(19) United States
(12) Patent Application Publication
(10) Pub. No.: US 2023/0245146 A1
(43) Pub. Date: Aug. 3, 2023

(54) METHODS AND APPARATUS FOR AUTOMATIC ITEM DEMAND AND SUBSTITUTION PREDICTION USING MACHINE LEARNING PROCESSES

(71) Applicant: Walmart Apollo, LLC, Bentonville, AR (US)

(72) Inventors: Avinash Thangali, New York, NY (US); Karthik Kumaran, Sunnyvale, CA (US)

(21) Appl. No.: 17/587,061

(22) Filed: Jan. 28, 2022

(51) Int. Cl. G06Q 30/02; G06Q 10/08

(52) U.S. Cl. CPC G06Q 30/0202; G06Q 10/087

(57) ABSTRACT

This application relates to employing trained machine learning processes to determine item substitutions, such as item substitutions for low-velocity items. For example, a computing device may generate features based on item data for a pair of low-velocity items. The computing device may apply a trained machine learning process to the generated features to determine a substitution score between the pair of low-velocity items. In some examples, and based on the substitution scores, the computing device may rank the low-velocity items. The computing device may receive a request for substitute items for one of the low-velocity items, and may transmit an indication of one or more of the other low-velocity items based on the ranking. In some examples, the computing device trains the machine learning process based on item data for high-velocity items and substitute scores between the high-velocity items.

### TECHNICAL FIELD

The disclosure relates generally to machine learning processes and, more specifically, to automatically generating item demand and substitution predictions using machine learning processes.

### BACKGROUND

Retailers can benefit from maximizing sales. For example, retailers may increase profits as sales increase. In some instances, however, retailers fail to stock or sell items customers are interested in purchasing, thus causing a decrease to their sales. For example, as variety in product assortment increases, retailers may not stock the most beneficial assortment of goods to sell. Having the right assortment, which caters effectively to the preferences of consumers, is of paramount importance. Space constraints in stores, however, may force a limited assortment of goods. Retailers must constantly make decisions on which items to stock and sell, which ultimately affects the sales of the retailer. In some instances, customer demand may transfer from one item to another item. For example, customer demand for a new item may reduce customer demand from an existing, yet similar, item. In some other instances, stores may not have available substitute items for an original item that, for example, is out of stock or is no longer sold. As such, there are benefits to determine item substitutes when, for example, an original item is in high demand or not available (e.g., out of stock), for example.

### SUMMARY

The embodiments described herein are directed to using trained machine learning processes to predict item substitutions and demand for retail items, such as low-velocity retail items. Low-velocity items may include items that are not frequently purchased, such as items within general merchandizing. By contrast, high-velocity items may include items that are frequently purchased, such as food and consumables. For example, a retailer may sell a plurality of items, where some of them are high-velocity and some of them are low-velocity. The embodiments generate substitution scores between pairs of high-velocity items, where the substitution scores are then used as training data to train machine learning models. During training, the machine learning models learn the relationship between the semantic features and corresponding ground-truth substitution scores in the high-velocity setting. The machine learning models then leverage this learned relationship to predict substitution scores between low-velocity items.

For instance, the embodiments may include generating features low-velocity item data (e.g., attributes), such as low-velocity item product descriptions. The embodiments may further include applying trained machine learning processes to the generated features to generate a predicted item substitution score. For example, the more similar the product descriptions of a pair of low-velocity items are, the higher the generated predicted item substitution score between those items. The trained machine learning processes may include, for example, a trained Bidirectional Encoder Representations from Transformers (BERT), such as a Sentence-BERT (SBERT) Bi-Encoder or SBERT Cross-Encoder. Based on the predicted item substitution scores, the embodiments may include generating a ranked list of substitute items (e.g., high-velocity items that can be substituted for the low-velocity item) for each low-velocity item. Further, the machine learning processes may be trained based on features generated from high-velocity item data, such as high-velocity item product descriptions, and high-velocity item substitution scores.

Among other advantages, the embodiments may allow a retailer to more reliably provide substitute items for original items, such as low-velocity items, when those low-velocity items are not available for sale. While substitution scores for high velocity items are currently tracked based on customer behavior and transaction data, there is a need to identify similar retail items and a measure of substitutability among low velocity items (those that do not sell very frequently). This can assist in stacking the right mix of items in the stores or for online purchases, and can eliminate items that are easily substitutable. Moreover, revenue and profits are maximized while catering to space constraints and limited assortment stocking in the stores. For example, a retailer may advertise the substitute items when a low-velocity item is out of stock or no longer available (e.g., not provided by a manufacturer. As such, the embodiments may allow retailers to increase sales, including in-store and online sales. Further, customers may benefit by being provided with more relevant item substitutions. Persons of ordinary skill in the art having the benefit of these disclosures would recognize these and other benefits as well.

In accordance with various embodiments, exemplary systems may be implemented in any suitable hardware or hardware and software, such as in one or more suitable computing devices. For example, in some embodiments, a computing device (e.g., server) comprising at least one processor obtains high-velocity item data for at least one high-velocity item, and low-velocity item data for at least one low-velocity item. The computing device generates a plurality of features based on the high-velocity item data and the low-velocity item data. Further, the computing device maps the plurality of features to output data characterizing a predicted substitution score. The computing device may store the predicted substitution score in a data repository.

In some embodiments, a method by at least one processor includes obtaining high-velocity item data for at least one high-velocity item, and low-velocity item data for at least one low-velocity item. The method also includes generating a plurality of features based on the high-velocity item data and the low-velocity item data. Further, the method includes mapping the plurality of features to output data characterizing a predicted substitution score. The method may also include storing the predicted substitution score in a data repository.

In some embodiments, a non-transitory computer readable medium has instructions stored thereon. The instructions, when executed by at least one processor, cause a device to perform operations that include obtaining high-velocity item data for at least one high-velocity item, and low-velocity item data for at least one low-velocity item. The operations also include generating a plurality of features based on the high-velocity item data and the low-velocity item data. Further, the operations include mapping the plurality of features to output data characterizing a predicted substitution score. The operations may also include storing the predicted substitution score in a data repository

In some embodiments, a computing device comprising at least one processor obtains high-velocity item data for each of a plurality of high-velocity items. The computing device also obtains substitution scores between the plurality of high-velocity items. The computing device generates features based on the high-velocity item data and the substitution scores. Further, the computing device trains a machine learning process based on the features to learn a mapping of the features to output data characterizing predicted substitution scores. The computing device also stores configuration parameters associated with the trained machine learning process in a data repository.

In some embodiments, a method by at least one processor includes obtaining high-velocity item data for each of a plurality of high-velocity items. The method also includes obtaining substitution scores between the plurality of high-velocity items. The method includes generating features based on the high-velocity item data and the substitution scores. Further, the method includes training a machine learning process based on the features to learn a mapping of the features to output data characterizing predicted substitution scores. The method also includes storing configuration parameters associated with the trained machine learning process in a data repository.

In some embodiments, a non-transitory computer readable medium has instructions stored thereon. The instructions, when executed by at least one processor, cause a device to perform operations that include obtaining high-velocity item data for each of a plurality of high-velocity items. The operations also include obtaining substitution scores between the plurality of high-velocity items. The operations include generating features based on the high-velocity item data and the substitution scores. Further, the operations include training a machine learning process based on the features to learn a mapping of the features to output data characterizing predicted substitution scores. The operations also include storing configuration parameters associated with the trained machine learning process in a data repository.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of an item substitution determination system in accordance with some embodiments;

FIG. 2 is a block diagram of an exemplary computing device in accordance with some embodiments;

FIG. 3 is a block diagrams illustrating examples of various portions of the item substitution determination system of FIG. 1 in accordance with some embodiments;

FIGS. 4A and 4B are block diagrams illustrating various portions of the item substitution determination computing device of FIG. 1 in accordance with some embodiments;

FIG. 5 is a flowchart of an example method that can be carried out by the item substitution determination system 100 of FIG. 1 in accordance with some embodiments; and

FIG. 6 is a flowchart of another example method that can be carried out by the item substitution determination system 100 of FIG. 1 in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

The embodiments employ machine learning processes to determine item substitutions for original items, such as for low-velocity items. Compared to high-velocity items, low-velocity items may be associated with less transaction data, such as transaction data identifying in-store or online purchases of the item. For example, the machine learning processes may be applied to features generated from item data, such as product descriptions, to generate output data characterizing a predicted similarity score between a high-velocity item and a low-velocity item. As an example, the machine learning processes may be applied to generate a first score between a low-velocity item and a first high-velocity item, a second score between the low-velocity item and a second high velocity item, and a third score between the low-velocity item and a third high velocity item. The first high-velocity item, second high-velocity item, and third high-velocity item may be ranked as substitute items based on the first score, second score, and third score, respectively.

The machine learning processes may be trained based on item data for high-velocity items, such as product descriptions, as well as substitution scores between the high-velocity items. For example, because high-velocity items tend to have more associated transactional data than low-velocity items, retailers may employ conventional methods to determine a substitution score between two high-velocity items. Regardless of how the substitution score between the high-velocity items is determined, the similarity scores may be employed as input features during the training of the machine learning processes. In some examples, a training set is used to fit machine learning model parameters. A validation set may then be used to select a best machine learning model (e.g., out of various machine learning models being trained), and a holdout set may be used for final performance measurement. Thus, by training the machine learning processes based on high-velocity item product descriptions and substitution scores, the machine learning processes learn to predict substitution scores between a low-velocity item, which may have no substitution information with any other item, and corresponding high velocity items.

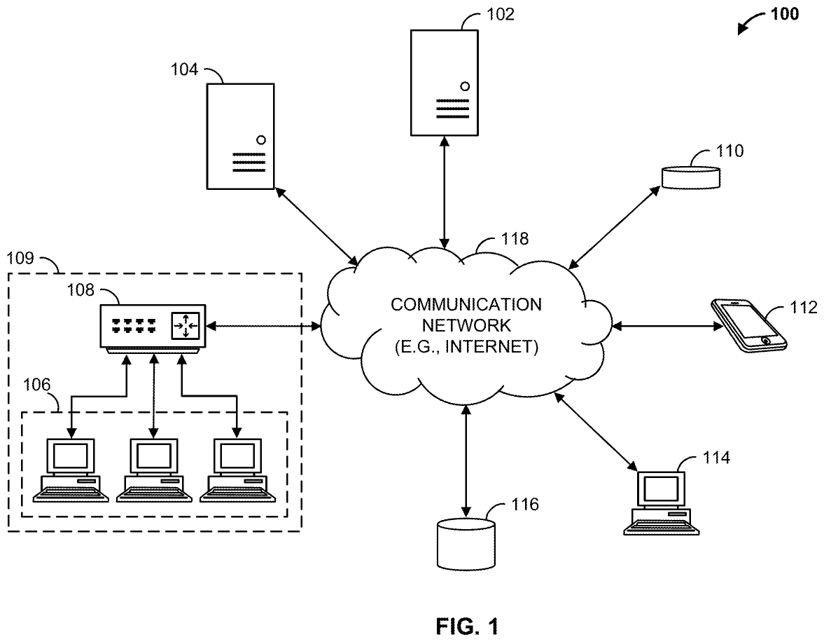

Turning to the drawings, FIG. 1 illustrates a block diagram of an item substitution determination system 100 that includes item substitution determination computing device 102 (e.g., a server, such as an application server), web server 104, workstation(s) 106, database 116, and multiple customer computing devices 110, 112, 114 operatively coupled over network 118. Item substitution determination computing device 102, workstation(s) 106, web server 104, and multiple customer computing devices 110, 112, 114 can each be any suitable computing device that includes any hardware or hardware and software combination for processing data. For example, each of item substitution determination computing device 102, web server 104, workstations 106, and multiple customer computing devices 110, 112, 114 can include one or more processors (e.g., each processor including one or more processing cores), one or more field-programmable gate arrays (FPGAs), one or more application-specific integrated circuits (ASICs), one or more state machines, digital circuitry, or any other suitable circuitry. In addition, each can transmit data to, and receive data from, communication network 118.

In some examples, item substitution determination computing device 102 can be a computer, a workstation, a laptop, a server such as a cloud-based server, a distributed computing system, or one or more of any other suitable device. Each of multiple customer computing devices 110, 112, 114 can be a mobile device such as a cellular phone, a laptop, a computer, a table, a personal assistant device, a voice assistant device, a digital assistant, or any other suitable device.

Although FIG. 1 illustrates three customer computing devices 110, 112, 114, item substitution determination system 100 can include any number of customer computing devices 110, 112, 114. Similarly, item substitution determination system 100 can include any number of workstation(s) 106, item substitution determination computing devices 102, web servers 104, and databases 116.

Workstation(s) 106 are operably coupled to communication network 118 via router (or switch) 108. Workstation(s) 106 and/or router 108 may be located at a store 109, for example. In some examples, workstation 106 is a register at store 109. Workstation(s) 106 can communicate with item substitution determination computing device 102 over communication network 118. The workstation(s) 106 may send data to, and receive data from, item substitution determination computing device 102. For example, the workstation(s) 106 may transmit data related to a transaction, such as a purchase transaction, to item substitution determination computing device 102. Workstation(s) 106 may also communicate with web server 104. For example, web server 104 may host one or more web pages, such as a retailer's website. Workstation(s) 106 may be operable to access and program (e.g., configure) the webpages hosted by web server 104 through, for example, an Application Programming Interface (API).

Database 116 can be a remote storage device, such as a cloud-based server, a memory device on another application server, a networked computer, or any other suitable remote storage. Item substitution determination computing device 102 is operable to communicate with database 116 over communication network 118. For example, item substitution determination computing device 102 can store data to, and read data from, database 116. Although shown remote to item substitution determination computing device 102, in some examples, database 116 can be a local storage device, such as a hard drive, a non-volatile memory, or a USB stick.

Communication network 118 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 118 can provide access to, for example, the Internet.

First customer computing device 110, second customer computing device 112, and N^{th} customer computing device 114 may communicate with web server 104 over communication network 118. For example, web server 104 may host one or more webpages of a website. Each of multiple computing devices 110, 112, 114 may be operable to view, access, and interact with the webpages hosted by web server 104. In some examples, web server 104 hosts a web page for a retailer that allows for the purchase of items. For example, an operator of one of multiple computing devices 110, 112, 114 may access the web page hosted by web server 104, add one or more items to an online shopping cart of the web page, and perform an online checkout of the shopping cart to purchase the items.

In some examples, web server 104 transmit a request to item substitution determination computing device 102 for item substitutions. For example, web server 104 may transmit a request for item substitution for an out of stock item. In response, item substitution determination computing device 102 may apply any of the machine learning processes described herein to determine one or more item substitutions for the out of stock item, and may transmit the one or more item substitutions to web server 104. Web server 104 may display an advertisement, such as an item webpage, for the received one or more item substitutions. For example, web server 104 may display the advertisement next to an advertisement for the out of stock item.

Generating Item Substitution Predictions

Item substitution determination computing device 102 may map features generated from product descriptions to output data using machine learning processes that are trained on high-velocity item pairs, but generate predictions for low-velocity item pairs during inference. For instance, item substitution determination computing device 102 may apply a trained machine learning process, such as a trained Sentence-BERT (SBERT) model, to features generated from product descriptions to generate output data. In some examples, item substitution determination computing device 102 generates features from a product description of a high-velocity item, and from a product description of a low-velocity item (e.g., an original, and out of stock, item), and applies the trained machine learning process to the generated features. The trained SBERT model may be, for example, an SBERT Bi-Encoder model, or an SBERT Cross-Encoder model. In other examples, the model may be a Doc2Vec model.

In the example of an SBERT Bi-Encoder model, the output data are sentence embeddings. Item substitution determination computing device 102 may further compare the sentence embeddings, such as by determining a cosine-similarity between the sentence embeddings, to generate a similarity score that falls within a similarity range (e.g., [0 to 1]). Moreover, during a fine-tuning process, the weights of the SBERT model are adjusted (e.g., trained) so that the model produces embeddings whose pairwise cosine-similarities are as close as possible to a corresponding set of pre-defined similarity labels over a training set (e.g., using supervised learning). Further, item substitution determination computing device 102 may scale (e.g., de-scale) the similarity scores to generate a final substitution score in a final substitution range (e.g., [−1 to 1]).

In the example of an SBERT Cross-Encoder model, the output data is the similarity scores. Further, item substitution determination computing device 102 may scale (e.g., de-scale) the similarity scores to generate a final substitution score in a final substitution range (e.g., [−1 to 1]).

The machine learning process may be trained based on features generated from item data, such as product descriptions, for a plurality high-velocity items, and corresponding substitution scores between the high-velocity items. In some examples, the machine learning process is trained until at least one metric threshold is satisfied. For example, the machine learning process (e.g., SBERT model) may be trained until a loss, such as a mean squared error (MSE) loss, is minimized over the training data set. For example, and during fine-tuning, the weights of the model may be adjusted until the at least one metric threshold is satisfied (e.g., until the at least one metric is below a threshold). In some instances, fine-tuning is performed using a Siamese neural network using an adam optimizer, and with batch size of 32.

In some examples, the machine learning process is validated using an out of sample data set. The out of sample data set may include product descriptions of high-velocity items and low-velocity items that did not appear in the training data set. For example, item substitution determination computing device 102 may generate features from a product description of a high-velocity item and from a product description of a low-velocity item. Further, item substitution computing device 102 may apply the SBERT model to the generated features to generate the output data. In the example of the SBERT Bi-Encoder model, item substitution determination computing device 102 may further determine a cosine-similarity between the sentence embeddings of the high-velocity item and the low velocity item to generate the similarity score; otherwise, in the example of the SBERT Cross-Encoder model, the output data is the similarity score.

Further, item substitution determination computing device 102 may compute a mean absolute error (MAE) between the similarity score and a corresponding ground truth value for a plurality of high-velocity item and low-velocity item pairs. Item substitution determination computing device 102 may determine the machine learning process is validated (e.g., has converged) if the MAE is below a predefined threshold, for example. Otherwise, if the MAE is not below the threshold, item substitution determination computing device 102 may continue to train the machine learning process with additional training data sets. In some examples, the machine learning processes may be trained for 15 epochs and the best model selected according to the performance on a respective validation set.

Once trained, item substitution determination computing device 102 may store the machine learning model parameters (e.g., hyperparameters, configuration settings, weights, etc.) associated with the machine learning process within database 116. As such, during inference, item substitution determination computing device 102 may obtain the parameters from database 116, configure the machine learning model with or based on the obtained parameters, and execute the machine learning model accordingly.

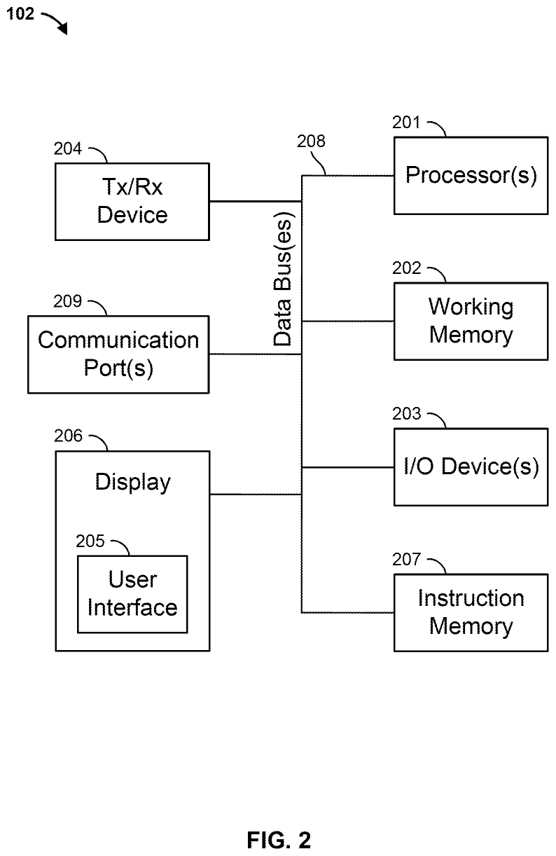

FIG. 2 illustrates an exemplary item substitution determination computing device 102 of FIG. 1. Item substitution determination computing device 102 can include one or more processors 201, working memory 202, one or more input/output devices 203, instruction memory 207, a transceiver 204, one or more communication ports 207, and a display 206, all operatively coupled to one or more data buses 208. Data buses 208 allow for communication among the various devices. Data buses 208 can include wired, or wireless, communication channels.

Processors 201 can include one or more distinct processors, each having one or more cores. Each of the distinct processors can have the same or different structure. Processors 201 can include one or more central processing units (CPUs), one or more graphics processing units (GPUs), application specific integrated circuits (ASICs), digital signal processors (DSPs), and the like.

Processors 201 can be configured to perform a certain function or operation by executing code, stored on instruction memory 207, embodying the function or operation. For example, processors 201 can be configured to perform one or more of any function, method, or operation disclosed herein.

Instruction memory 207 can store instructions that can be accessed (e.g., read) and executed by processors 201. For example, instruction memory 207 can store instructions that, when executed by one or more processors 201, cause the one or more processors 201 to perform any of the operations described herein, including training and executing any of the machine learning processes described herein. Instruction memory 207 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 201 can store data to, and read data from, working memory 202. For example, processors 201 can store a working set of instructions to working memory 202, such as instructions loaded from instruction memory 207. Processors 201 can also use working memory 202 to store dynamic data created during the operation of item substitution determination computing device 102. Working memory 202 can be a random access memory (RAM) such as a static random access memory (SRAM) or dynamic random access memory (DRAM), or any other suitable memory.

Input-output devices 203 can include any suitable device that allows for data input or output. For example, input-output devices 203 can include one or more of a keyboard, a touchpad, a mouse, a stylus, a touchscreen, a physical button, a speaker, a microphone, or any other suitable input or output device.

Communication port(s) 209 can include, for example, a serial port such as a universal asynchronous receiver/transmitter (UART) connection, a Universal Serial Bus (USB) connection, or any other suitable communication port or connection. In some examples, communication port(s) 209 allows for the programming of executable instructions in instruction memory 207. In some examples, communication port(s) 209 allow for the transfer (e.g., uploading or downloading) of data, such as training data.

Display 206 can display user interface 205. User interfaces 205 can enable user interaction with item substitution determination computing device 102. For example, user interface 205 can be a user interface for an application of a retailer that allows a customer to purchase one or more items from the retailer. In some examples, a user can interact with user interface 205 by engaging input-output devices 203. In some examples, display 206 can be a touchscreen, where user interface 205 is displayed on the touchscreen.

Transceiver 204 allows for communication with a network, such as the communication network 118 of FIG. 1. For example, if communication network 118 of FIG. 1 is a cellular network, transceiver 204 is configured to allow communications with the cellular network. In some examples, transceiver 204 is selected based on the type of communication network 118 item substitution determination computing device 102 will be operating in. Processor(s) 201 is operable to receive data from, or send data to, a network, such as communication network 118 of FIG. 1, via transceiver 204.

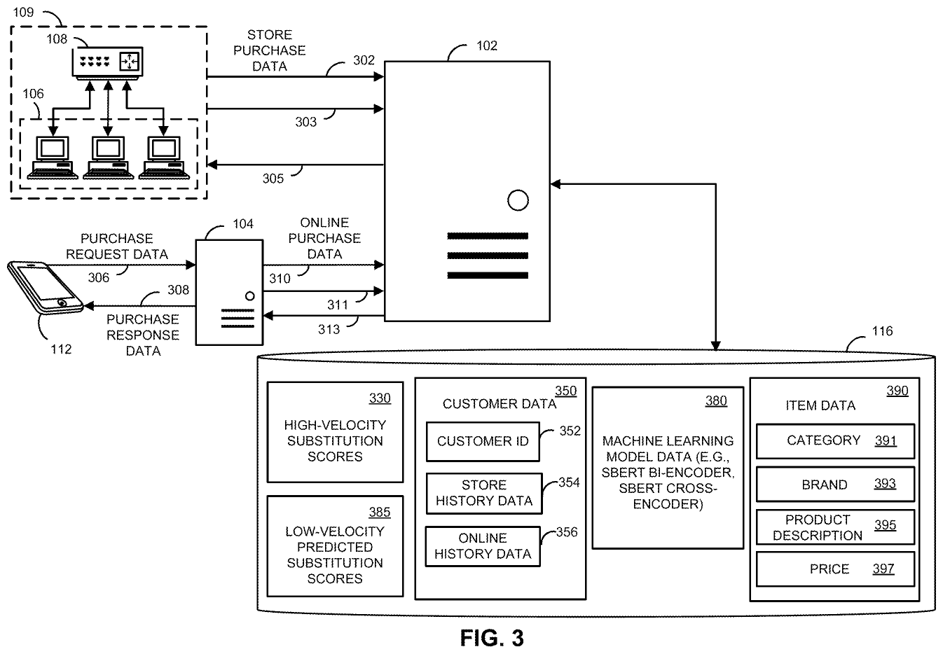

FIG. 3 is a block diagram illustrating examples of various portions of the item substitution determination system of FIG. 1. In this example, database 116 stores item data 390, which may include a catalog of items sold at one or more stores 109 and items sold online. For example, item data 390 may include, for each item, a category 391 (e.g., home goods, food, lawn, etc.), a brand 393, a product description 395 (e.g., may include description, color, size, packaging type, etc.), and a price 397. Database 116 also stores machine learning model data 380, which may store machine learning model parameters (e.g., hyperparameters, configuration settings, weights, etc.) of a trained machine learning model process. For example, machine learning model data 380 may include machine learning model parameters of a trained SBERT Bi-Encoder model, or trained SBERT Cross-Encoder model. As described herein, item substitution determination computing device 102 can retrieve machine learning model data 380 from database 116 to configure a machine learning process to generate low-velocity item substitution scores during inference.

Further, item substitution determination computing device 102 can receive from a store 109 (e.g., from a computing device, such as workstation 106, at store 109) store purchase data 302 identifying the purchase of one or more items. Store purchase data 302 may include, for example, one or more of the following: an identification of one or more items being purchased; a price of each item being purchased; an identification of the customer (e.g., customer ID, passport ID, driver's license number, etc.); a method of payment (i.e., payment form) used to purchase the items (e.g., credit card, cash, check); a Universal Product Code (UPC) number for each item; a time and/or date; and/or any other data related to the purchase transaction.

Item substitution determination computing device 102 may parse store purchase data 302 and extract data associated with the purchase, and store the extracted data within database 116. For example, item substitution determination computing device 102 may store the extracted information, which may include one or more of the item IDs, item prices, customer ID, payment form, and item UPC numbers, as customer data 350 within database 116. For instance, customer data 350 may include, for each of a plurality of customers, a customer ID 352 which characterizes one or more customer IDs, and corresponding store history data 354, which may include one or more of the item IDs, item prices, customer ID, payment form, and item UPC numbers for each purchase at store 109.

Similarly, item substitution determination computing device 102 can receive from a web server 104, such as a web server hosting a retailer's website, online purchase data 310 identifying the purchase of one or more items from the website. For example, web server 104 may receive purchase request data 306 from customer computing device 112, where purchase request data 306 identifies a request to purchase one or more items from a website, such as a retailer's website. Web server 104 may generate online purchase data 310 based on purchase request data 306. For example, online purchase data 310 may include one or more of the following: an identification of one or more items being purchased; a price of each item being purchased; an identification of the customer (e.g., customer ID, passport ID, driver's license number, etc.); a method of payment (i.e., payment form) used to purchase the items (e.g., credit card, cash, check); a Universal Product Code (UPC) number for each item; a time and/or date; and/or any other data related to the purchase transaction. Web server 104 may process purchase request data 104 to establish the purchase of the items, and may generate purchase response data 308 confirming the purchase of the items, and may transmit purchase response data 308 to customer computing device 112. Moreover, web server 104 may generate online purchase data 310 characterizing the purchase, and may transmit online purchase data 310 to item substitution determination computing device 102. For example, online purchase data 310 may include one or more of: a customer ID, one or more item IDs, one or more item prices, payment form, and one or more item UPC numbers.

Item substitution determination computing device 102 may parse online purchase data 310 and extract data associated with the purchase, and store the extracted data within database 116. For example, item substitution determination computing device 102 may store the extracted information, which may include one or more of the item IDs, item prices, customer ID, payment form, and item UPC numbers, as customer data 350 within database 116. For instance, customer data 350 may include, for each of a plurality of customers, a customer ID 352 which characterizes one or more customer IDs, and corresponding online history data 356, which may include one or more of the item IDs, item prices, customer ID, payment form, item UPC numbers, and delivery speeds (e.g., how long from purchase to a promised, or actual, delivery time) for each purchase on the website hosted by web server 104.

Based on customer data 350, item substitution determination computing device 102 may generate high-velocity substitution scores 330 for one or more high-velocity items. For example, item substitution determination computing device 102 may parse customer data 350 to determine a number of transactions, within one or more of store history data 354 and online history data 356, involving each of a plurality of items over a temporal period (e.g., over a previous month, quarter, year, holiday season, etc.). For example, item substitution determination computing device 102, for an item with a given item ID, item substitution determination computing device 102 may determine a number of store transactions that include the item, and a number of online transactions that include the item, over the temporal period (e.g., for all customers). In addition, and based on the number of store transactions and the number of online transactions for the item, item substitution determination computing device 102 may determine whether the item is a high-velocity item. For example, item substitution determination computing device 102 may sum the number of store transactions and the number of online transactions for the item, and determine whether the sum is at or above a predetermined threshold (e.g., 10,000 transactions). If the sum is at or above the threshold, item substitution determination computing device 102 may generate a label 399 within item data 390 for the item labelling the item as high-velocity. Otherwise, if the sum is not at or above the threshold, item substitution determination computing device 102 may generate the label 399 within item data 390 for the item labelling the item as low-velocity.

To train the machine learning processes described herein, such as the SBERT Bi-Encoder model, or the SBERT Cross-Encoder model, item substitution determination computing device 102 may generate features based on item data 390 and substitution scores between pairs of high-velocity items. For example, based on the items labelled as high-velocity, item substitution determination computing device 102 may apply any process to generate substitution scores 330 (e.g., ground truth values) between pairs of the high-velocity items. For instance, item substitution determination computing device 102 may apply deterministic business logic (e.g., one or more rules) to product descriptions of each of the pairs of the high-velocity items (e.g., product description 395 obtained from item data 390) to generate the generate substitution scores 330 between pairs of the high-velocity items. In some examples, item substitution determination computing device 102 may apply a doc2vec model, or a word2vec model, to product descriptions of each of the pairs of the high-velocity items (e.g., product description 395 obtained from item data 390) to generate an output vector for each, and may determine a cosine similarity score between the vectors to determine the high-velocity substitution score 330 between the pair of high-velocity items. Item substitution determination computing device 102 may store the high-velocity substitution scores 330 within database 116.

Further, item substitution determination computing device 102 may generate features based on the product descriptions for each pair of high-velocity items, and their corresponding high-velocity substitution score 330. Item substitution determination computing device 102 may apply the machine learning process to the generated features for training (e.g., to train the corresponding model weights). In some examples, item substitution determination computing device 102 trains the machine learning process until at least one metric is satisfied. For example, item substitution determination computing device 102 may train the machine learning process until a loss, such as an MSE loss, is minimized over the training data set.

Further, item substitution determination computing device 102 may generate a validation set based on item data 390 from additional high-velocity items. For instance, item substitution determination computing device 102 may generate features from each product description 395 of the additional plurality of high-velocity items. The validation set may include product descriptions 395 of items that are not included in the training data set. Further, item substitution computing device 102 may apply the initially trained machine learning process to the generated features to generate output data. In the example of an SBERT Bi-Encoder model, the output data characterizes sentence embeddings. Item substitution determination computing device 102 may further determine a cosine-similarity between the sentence embeddings of the high-velocity item and the low velocity item to generate the similarity score. In the example of the SBERT Cross-Encoder model, the output data is the similarity score.

Further, item substitution determination computing device 102 may compute a metric, such as an MAE between the similarity score and a corresponding ground truth value (e.g., ground truth substitution label). Item substitution determination computing device 102 may determine the machine learning process is validated and sufficiently trained (e.g., has converged) when the MAE is below a predefined threshold. If, however, the MAE is not below the threshold, item substitution determination computing device 102 may continue to train the machine learning process with additional training data sets, and validating the machine learning process with validation sets, until the metric is satisfied (e.g., until the MAE is below the threshold). Once the machine learning process is converged, item substitution determination computing device 102 may store the machine learning model parameters (e.g., hyperparameters, configuration settings, weights, etc.) associated with the trained machine learning model process as machine learning model data 380 within database 116.

Once trained, item substitution determination computing device 102 may generate substitution scores for one or more low-velocity items based on corresponding high-velocity items. For example, item substitution determination computing device 102 may obtain a product description 395 for a low-velocity item, and product descriptions 395 for a plurality of high-velocity items. Further, item substitution determination computing device 102 may generate features based on the product descriptions 395, and may apply the trained machine learning process to the generated features to generate the substitution scores. Item substitution determination computing device 102 may rank, for a corresponding low-velocity item, the plurality of high-velocity items based on their corresponding substitution scores, and may store the ranked list of items, and their corresponding substitution scores, as low-velocity predicted substitution scores 385 within database 116. In some examples, item substitution determination computing device 102 generates low-velocity predicted substitution scores 385 for one or more low-velocity items of item data 390 on a periodic or occasional bases (e.g., weekly, monthly, quarterly, nightly, etc.).

Item substitution determination computing device 102 may receive, from web server 104, an item substitution request 311 to request item substitutions for one or more items. For example, item substitution request 311 may include an item ID of a particular item. Item substitution determination computing device 102 may determine, based on the low-velocity predicted substitution scores 385 corresponding to the requested item, one or more substitution items for the requested item. Item substitution determination computing device 102 may generate an item substitution response 313 identifying the substitute items, and may transmit the item substitution response 313 to web server 104. In some examples, item substitution response 313 identifies a ranking of the substitute items according the substitution scores. Based on item substitution response 313, web server 104 may, for example, display advertisements for the substitute items (e.g., in lieu of advertisements for the original item identified within the item substitution request 303).

Similarly, item substitution determination computing device 102 may receive, from store 109 (e.g., via workstation 106), an item substitution request 303 to request item substitutions for one or more items. For example, item substitution request 303 may include an item ID of a particular item. Item substitution determination computing device 102 may determine, based on the low-velocity predicted substitution scores 385 corresponding to the requested item, one or more substitution items for the requested item. Item substitution determination computing device 102 may generate an item substitution response 305 identifying the substitute items, and may transmit the item substitution response 305 to store 109. In some examples, item substitution response 305 identifies a ranking of the substitute items according the substitution scores. Based on item substitution response 305, store 109 may, for example, place one or more of the substitute items on a shelf (e.g., in lieu of the original item identified within the item substitution request 303, which may be out of stock).

In some examples, item substitution determination computing device 102 may generate the low-velocity predicted substitution scores 385 in real-time. For example, upon receiving an item substitution request 303, 311, item substitution determination computing device 102 may generate the low-velocity predicted substitution scores 385 for the requested item, and may transmit the item substitution response 305, 313 identifying one or more substitute items based on the generated low-velocity predicted substitution scores 385.

In some examples, item substitution determination computing device 102 may determine if the item requested via item substitution request 303, 311 is a low-velocity item (e.g., based on the corresponding label 399 within item data 390, as described herein). If the requested item is a low-velocity item, item substitution determination computing device 102 may determine the low-velocity predicted substitution scores 385, and generate and transmit the item substitution response 305, 313, as described herein. If, however, the item requested is a high-velocity item, item substitution determination computing device 102 may determine the item substitutions based on high-velocity substitution scores 330. For example, item substitution determination computing device 102 may determine one or more high-velocity substitutions for the requested item based on the corresponding high-velocity substitution scores 330, and may generate the item substitution response 305, 313 to identify one or more high-velocity items based on the corresponding high-velocity substitution scores 330. Further, item substitution determination computing device 102 may transmit the item substitution response 305, 313 identifying the high-velocity substitute items in response to the received item substitution request 303, 311.

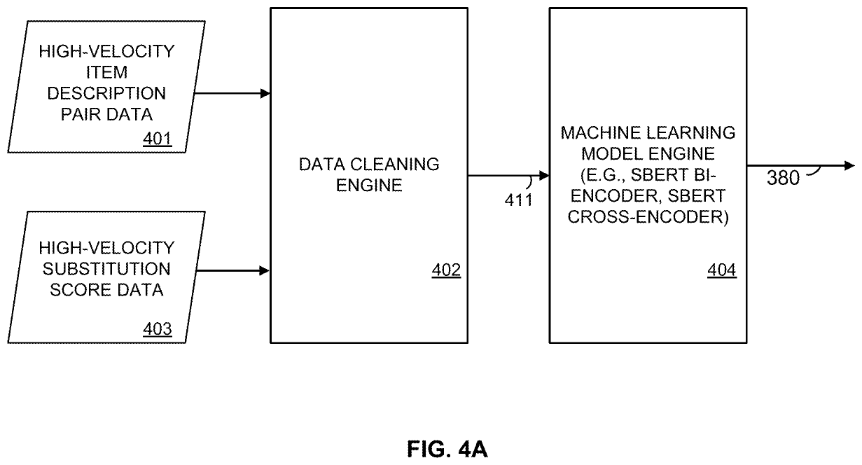

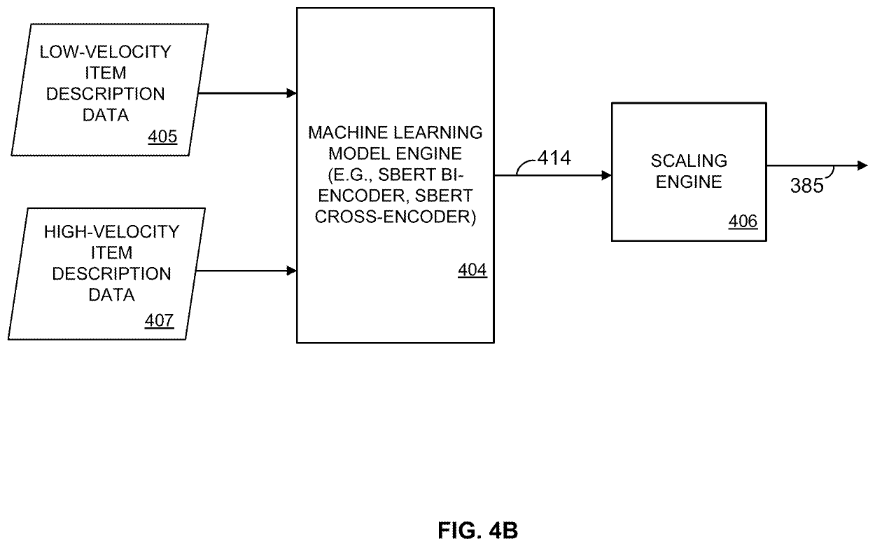

FIG. 4A illustrates exemplary portions of item substitution determination computing device 102 that train a machine learning process, such as a process that includes an SBERT Bi-Encoder or SBERT Cross-Encoder. For example, data cleaning engine 402 receives high-velocity item description pair data 401 and corresponding high-velocity substitution score data 403. High-velocity item description pair data 401 may characterize product descriptions between a pair of high-velocity items, and high-velocity substitution score data 403 may characterize a substitution score between the pair of high velocity items. For example, data cleaning engine 402 may perform operations to sample database 116 to retrieve product descriptions 395 for pairs of high velocity items, and their corresponding high-velocity substitution scores 330, to generate a training set. Further, data cleaning engine 402 may generate a validation set based on additional high-velocity items, and may perform further operations to ensure there are no high-velocity item overlaps between the training set and validation set.

Further, data cleaning engine 402 may generate features 411 based on the training set, and may provide the features 411 to machine learning model engine 404 to train a machine learning process, such as an SBERT Bi-Encoder or SBERT Cross-Encoder. Machine learning model engine 404 may train the machine learning process with the generated features until, for example, at least one metric is satisfied, as described herein. Once initially trained, data cleaning engine 402 may generate features based on the validation set, and may provide the generated features to the machine learning model engine 404 to validate the initially trained machine learning process.

Machine learning model engine 404 may determine, based on the output data generated, whether the machine learning process has converged and is sufficiently trained. For example, machine learning model engine 404 may compute at least one metric based on generated substitution scores and corresponding ground truth data, and determine if the machine learning process has converged and is sufficiently trained based on the computed metric. If machine learning model engine 404 determines the machine learning process is sufficiently trained, machine learning model engine 404 stores machine learning model parameters (e.g., hyperparameters, configuration settings, weights, etc.) associated with the trained machine learning model process as machine learning model data 380 within database 116. If the machine learning model engine 404 determines the machine learning process is not sufficiently trained, data cleaning engine 402 may generate additional training and validation sets to continue training the machine learning process.

FIG. 4B illustrates exemplary portions of item substitution determination computing device 102 that apply the trained machine learning process of FIG. 4A to features generated from item data to generate substitution scores. For example, machine learning model engine 404 may receive low-velocity item description data 405 and high-velocity item description data 407. Low-velocity item description data 405 may characterize features generated from a product description 395 of a low-velocity item, and high-velocity item description data 407 may characterize features generated from a product description 395 of corresponding high-velocity item. For example, low-velocity item description data 405 may characterize a product description for an item received in an item substitution request 303, 311. Machine learning model engine 404 may apply a trained machine learning process to low-velocity item description data 405 and high-velocity item description data 407 to generate output data 414. For example, machine learning model engine 404 may obtain machine learning model data 380 from database 116, and may configure the machine learning process in accordance with the machine learning model parameters of machine learning model data 380. The trained machine learning process may include, for example, a trained SBERT Bi-Encoder model or trained SBERT Cross-Encoder model.

In the example of an SBERT Bi-Encoder model, output data 414 are sentence embeddings. Scaling engine 406 may compare the sentence embeddings, such as by determining a cosine-similarity between the sentence embeddings, to generate a similarity score that falls within a similarity range (e.g., [0 to 1]). Further, scaling engine 406 may scale (e.g., de-scale) the similarity scores to generate a low-velocity predicted substitution score 385 that is within a substitution range (e.g., [−1 to 1]). In the example of an SBERT Cross-Encoder model, the output data 414 are similarity scores. Scaling engine 406 may scale (e.g., de-scale) the similarity scores to generate a low-velocity predicted substitution score 385 that is within the substitution range (e.g., [−1 to 1]). Scaling engine 406 may store the low-velocity predicted substitution score 385 within database 116.

In some examples, one or more of data cleaning engine 402, machine learning model engine 404, and scaling engine 406 may be implemented in hardware. In some examples, one or more of data cleaning engine 402, machine learning model engine 404, and scaling engine 406 may be implemented as an executable program maintained in a tangible, non-transitory memory, such as instruction memory 207 of FIG. 2, which may be executed by one or processors, such as processor 201 of FIG. 2.

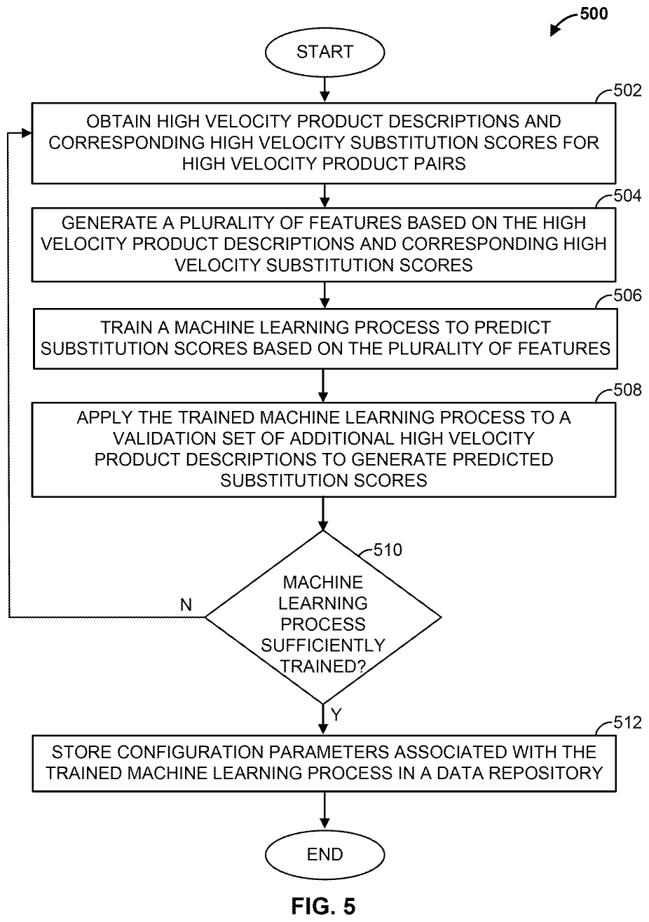

FIG. 5 is a flowchart of an example method 500 that can be carried out by the item substitution determination computing device 102 of FIG. 1. Beginning at step 502, item substitution determination computing device 102 obtains (e.g., from database 116) high-velocity product descriptions (e.g., high-velocity product descriptions 395) and corresponding high velocity substitution scores (e.g., high-velocity substitution scores 330) for high-velocity product pairs. At step 504, item substitution determination computing device 102 generates a plurality of features based on the high-velocity product descriptions and corresponding high velocity substitution scores.

Proceeding to step 506, item substitution determination computing device 102 trains a machine learning process to predict substitution scores based on the plurality of features. Item substitution determination computing device 102 may train the machine learning process until at least one metric satisfies a threshold, as described herein. Further, and at step 508, item substitution determination computing device 102 applies the initially trained machine learning process to a validation set that includes additional high-velocity product descriptions (i.e., product descriptions 395 for high-velocity items). Item substitution determination computing device 102 may ensure that no high-velocity items overlap between the training set and the validation set.

At step 510, item substitution determination computing device 102 may determine if the machine learning process is sufficiently trained. For example, item substitution determination computing device 102 may compare the output data generated during application of the machine learning process to the validation set to ground truth data, and may determine if at least one metric satisfies a threshold, as described herein. If item substitution determination computing device 102 determines that the machine learning process is not sufficiently trained, the method proceeds back to step 502 to generate an additional training set. Otherwise, if item substitution determination computing device 102 determines the machine learning process is sufficiently trained, the method proceeds to step 512. At step 512, item substitution determination computing device 102 stores configuration parameters associated with the trained machine learning process in a data repository (e.g., machine learning model data 380 within database 116). The method then ends.

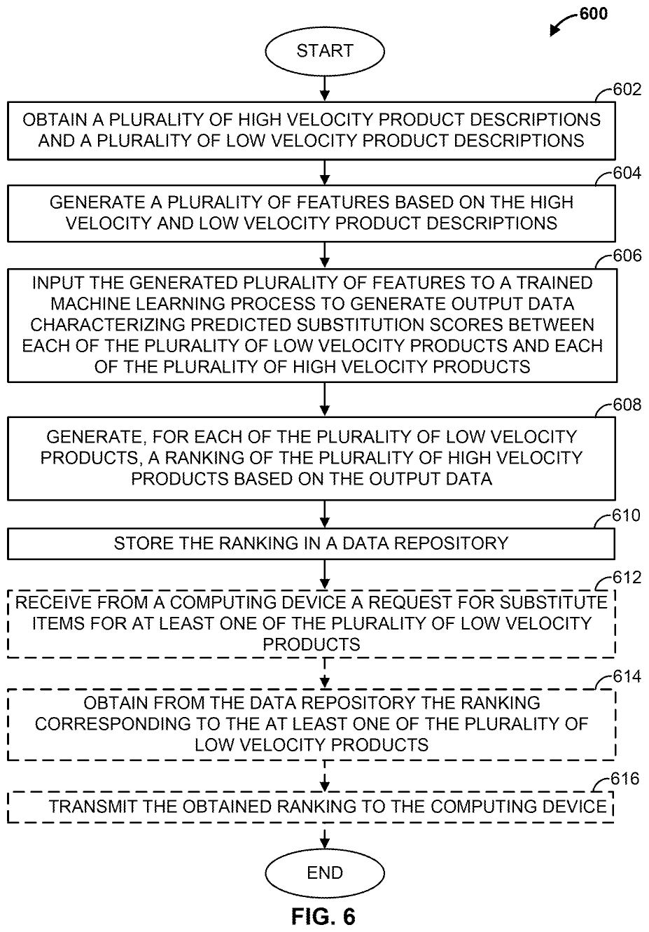

FIG. 6 is a flowchart of an example method 600 that can be carried out by the item substitution determination computing device 102 of FIG. 1. Beginning at step 602, item substitution determination computing device 102 obtains a plurality of high-velocity product descriptions (e.g., high-velocity product descriptions 395) and a plurality of low-velocity product descriptions (e.g., low-velocity product descriptions 395). At step 604, item substitution determination computing device 102 generates a plurality of features based on the high-velocity product descriptions and the low-velocity product descriptions.

Proceeding to step 606, item substitution determination computing device 102 inputs the generated plurality of features to a trained machine learning process, such as the trained machine learning process of FIG. 5, to generate output data. The output data characterizes predicted substitution scores between each of the plurality of low-velocity products and each of the plurality of high-velocity products. Further, at step 608, item substitution determination computing device 102 may generate, for each of the plurality of low-velocity products, a ranking of the plurality of high-velocity products based on the output data. Thus, in this example, one or more of the high-velocity products may serve as a substitute to each of the plurality of low-velocity products. Item substitution determination computing device 102 may store the rankings in a data repository (e.g., low-velocity substitution scores 330 within database 116). The method may then end.

In some examples, however, item substitution determination computing device 102 may receive, from another computing device (e.g., workstation 106, web server 104) a request for substitute items for at least one of the plurality of low-velocity products (e.g., item substitution request 303, 311). In response, item substitution determination computing device 102 may obtain, from the data repository, the ranking corresponding to the at least one of the plurality of low-velocity products (e.g., the low-velocity substitution scores 330 within database 116 for the at least one of the plurality of low-velocity product). Further, and at step 616, item substitution determination computing device 102 may transmit the obtained ranking to the computing device (e.g., item substitution determination computing device 102 may transmit item substitution response 305, 313 to workstation 106 or web server 104). The method then ends.

In some examples, item substitution determination computing device 102 obtains a plurality of low-velocity product descriptions (e.g., low-velocity product descriptions 395), and generates a plurality of features based on the low-velocity product descriptions.

Further, item substitution determination computing device 102 inputs the generated plurality of features to a trained machine learning process, such as the trained machine learning process of FIG. 5, to generate output data. The output data characterizes predicted substitution scores between each of the plurality of low-velocity products. Item substitution determination computing device 102 may then generate, for each of the plurality of low-velocity products, a ranking of the plurality of low-velocity products based on the output data. Thus, in this example, one or more of the plurality of low-velocity products may serve as a substitute to each of the plurality of low-velocity products. Item substitution determination computing device 102 may store the rankings in a data repository (e.g., low-velocity substitution scores 330 within database 116).

Although the methods described above are with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

Further, although some of the machine learning processes are described herein as being trained with, and operating on during inference, features generated from product descriptions, in other examples the machine learning processes may be trained with, and operate on, features generated from any suitable item data, including any suitable item attributes (e.g., brand, color, packaging, category, etc.).

The following clause listing includes exemplary embodiments.
1. A system comprising:
a computing device comprising at least one processor, where the computing device is configured to:
   obtain first item data for a first item and second item data for a plurality of second items;
   generate a plurality of features based on the first item data and the second item data;
   map the plurality of features to output data characterizing a predicted substitution score; and
   store the predicted substitution score in a data repository.
2. The system of clause 1, wherein each of the first item and the plurality of second devices are low-velocity items.
3. The system of any of clauses 1-2, wherein mapping the plurality of features to the output data comprises establishing a Sentence Bidirectional Encoder Representations from Transformers (SBERT) model.
4. The system of clause 3, wherein the computing device is configured to:
obtain product descriptions of a plurality of third items;
obtain substitution scores between the plurality of third items;
generate features based on the product descriptions and the substitution scores; and apply the SBERT model to the generated features to learn the mapping of the plurality of features to the output data.
5. The system of clause 4, wherein the computing device is configured to store machine learning model parameters associated with the SBERT model in a data repository.
6. The system of any of clauses 1-5, wherein each of the first item data and the second item data comprises product descriptions.
7. The system of any of clauses 1-6, wherein mapping the plurality of features to the output data comprises scaling the output data to generate the predicted substitution score, wherein the predicted substitution score is within a substitution range.
8. The system of any of clauses 1-7, wherein mapping the plurality of features to the output data comprises:

generating a plurality of sentence embeddings; and

computing a cosine-similarity of the plurality of sentence embeddings to determine the predicted substitution score.
9. The system of any of clauses 1-8, wherein the computing device is configured to: receive an item substitution request for the first item; and generate and transmit, in response to the item substitution request, an item substitution response based on the predicted substitution score.
10. A method comprising:
obtaining first item data for a first item and second item data for a plurality of second items;
generating a plurality of features based on the first item data and the second item data;
mapping the plurality of features to output data characterizing a predicted substitution score; and
storing the predicted substitution score in a data repository.
11. The method of clause 10 wherein each of the first item and the plurality of second devices are low-velocity items.
12. The method of any of clauses 10-11 wherein mapping the plurality of features to the output data comprises establishing a Sentence Bidirectional Encoder Representations from Transformers (SBERT) model.
13. The method of any of clauses 10-12 comprising:
obtaining product descriptions of a plurality of third items;
obtaining substitution scores between the plurality of third items;
generating features based on the product descriptions and the substitution scores; and applying the SBERT model to the generated features to learn the mapping of the plurality of features to the output data.
14. The method of any of clauses 10-13 wherein each of the first item data and the second item data comprises product descriptions.
15. The method of any of clauses 10-14 wherein mapping the plurality of features to the output data comprises scaling the output data to generate the predicted substitution score, wherein the predicted substitution score is within a substitution range.
16. The method of any of clauses 10-15 wherein mapping the plurality of features to the output data comprises:
generating a plurality of sentence embeddings; and
computing a cosine-similarity of the plurality of sentence embeddings to determine the predicted substitution score.
17. The method of any of clauses 10-16 comprising:
receiving an item substitution request for the first item; and
generating and transmitting, in response to the item substitution request, an item substitution response based on the predicted substitution score.
18. A non-transitory computer readable medium having instructions stored thereon, wherein the instructions, when executed by at least one processor, cause a device to perform operations comprising:
obtaining first item data for a first item and second item data for a plurality of second items;
generating a plurality of features based on the first item data and the second item data;
mapping the plurality of features to output data characterizing a predicted substitution score; and
storing the predicted substitution score in a data repository.
19. The non-transitory computer readable medium of clause 18, wherein each of the first item and the plurality of second devices are low-velocity items.
20. The non-transitory computer readable medium of any of clauses 18-19, wherein mapping the plurality of features to the output data comprises establishing a Sentence Bidirectional Encoder Representations from Transformers (SBERT) model.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
a computing device comprising at least one processor, where the computing device is configured to:
obtain first item data for a first item and second item data for a plurality of second items;
generate a plurality of features based on the first item data and the second item data;
map the plurality of features to output data characterizing a predicted substitution score; and
store the predicted substitution score in a data repository.

2. The system of claim 1, wherein each of the first item and the plurality of second devices are low-velocity items.

3. The system of claim 1, wherein mapping the plurality of features to the output data comprises establishing a Sentence Bidirectional Encoder Representations from Transformers (SBERT) model.

4. The system of claim 3, wherein the computing device is configured to:
obtain product descriptions of a plurality of third items;
obtain substitution scores between the plurality of third items;
generate features based on the product descriptions and the substitution scores; and
apply the SBERT model to the generated features to learn the mapping of the plurality of features to the output data.

5. The system of claim 4, wherein the computing device is configured to store machine learning model parameters associated with the SBERT model in a data repository.

6. The system of claim 1, wherein each of the first item data and the second item data comprises product descriptions.

7. The system of claim 1, wherein mapping the plurality of features to the output data comprises scaling the output data to generate the predicted substitution score, wherein the predicted substitution score is within a substitution range.

8. The system of claim 1, wherein mapping the plurality of features to the output data comprises:
generating a plurality of sentence embeddings; and
computing a cosine-similarity of the plurality of sentence embeddings to determine the predicted substitution score.

9. The system of claim 1, wherein the computing device is configured to:
receive an item substitution request for the first item; and
generate and transmit, in response to the item substitution request, an item substitution response based on the predicted substitution score.

10. A method comprising:
obtaining first item data for a first item and second item data for a plurality of second items;
generating a plurality of features based on the first item data and the second item data;
mapping the plurality of features to output data characterizing a predicted substitution score; and
storing the predicted substitution score in a data repository.

11. The method of claim 10 wherein each of the first item and the plurality of second devices are low-velocity items.

12. The method of claim 10 wherein mapping the plurality of features to the output data comprises establishing a Sentence Bidirectional Encoder Representations from Transformers (SBERT) model.

13. The method of claim 12 comprising:
obtaining product descriptions of a plurality of third items;
obtaining substitution scores between the plurality of third items;
generating features based on the product descriptions and the substitution scores; and
applying the SBERT model to the generated features to learn the mapping of the plurality of features to the output data.

14. The method of claim 10 wherein each of the first item data and the second item data comprises product descriptions.

15. The method of claim 10 wherein mapping the plurality of features to the output data comprises scaling the output data to generate the predicted substitution score, wherein the predicted substitution score is within a substitution range.

16. The method of claim 10 wherein mapping the plurality of features to the output data comprises:
generating a plurality of sentence embeddings; and
computing a cosine-similarity of the plurality of sentence embeddings to determine the predicted substitution score.

17. The method of claim 10 comprising:
receiving an item substitution request for the first item; and
generating and transmitting, in response to the item substitution request, an item substitution response based on the predicted substitution score.

18. A non-transitory computer readable medium having instructions stored thereon, wherein the instructions, when executed by at least one processor, cause a device to perform operations comprising:
obtaining first item data for a first item and second item data for a plurality of second items;
generating a plurality of features based on the first item data and the second item data;
mapping the plurality of features to output data characterizing a predicted substitution score; and
storing the predicted substitution score in a data repository.

19. The non-transitory computer readable medium of claim 18, wherein each of the first item and the plurality of second devices are low-velocity items.

20. The non-transitory computer readable medium of claim 18, wherein mapping the plurality of features to the output data comprises establishing a Sentence Bidirectional Encoder Representations from Transformers (SBERT) model.
